(19) United States
(12) Patent Application Publication
(10) Pub. No.: US 2019/0278503 A1
(43) Pub. Date: Sep. 12, 2019

(54) NVRAM MEMORY MODULE WITH HARD WRITE THROTTLE DOWN

(71) Applicant: Intel Corporation, Santa Clara, CA (US)

(72) Inventors: Sowmiya JAYACHANDRAN, Portland, OR (US); Andrew MORNING-SMITH, Vancouver (CA); Brian R. MCFARLANE, Hillsboro, OR (US); William T. GLENNAN, Folson, CA (US); Emily P. CHUNG, Austin, TX (US)

(21) Appl. No.: 16/425,883

(22) Filed: May 29, 2019

(51) Int. Cl. G06F 3/06; G06F 1/30; G06F 11/30

(52) U.S. Cl. CPC G06F 3/0634; G06F 3/0611; G06F 11/3034; G06F 3/0658; G06F 3/0688; G06F 1/305

(57) ABSTRACT

A method is described. The method includes performing write operations on a plurality of NVRAM semiconductor chips of a memory module while tracking power budget headroom for performing the write operations and while monitoring current draw on a supply voltage rail that is coupled to the plurality of NVRAM semiconductor chips. The method further includes detecting the current draw has reached a threshold. The method further includes ceasing or diminishing the write operations in response to the detecting.

### FIELD OF INVENTION

The field of invention pertains generally to the electrical arts, and, more specifically, to an NVRAM memory module with hard write throttle down.

### BACKGROUND

The onset of “big data”, “cloud computing” and other data center centric computing paradigms is driving the development of new memory and storage technologies because these paradigms rapidly access tremendous amounts of information. Such new memory and storage technologies, however, raise new implementation challenges that system designers must recognize and overcome.

### FIGURES

A better understanding of the present invention can be obtained from the following detailed description in conjunction with the following drawings, in which:

FIG. 1 shows a traditional memory module having NVRAM semiconductor chips;

FIG. 2 shows an improved memory module having NVRAM semiconductor chips;

FIG. 3 shows an embodiment of the operation of the improved memory module of FIG. 2;

FIG. 4 shows a computing system.

### DETAILED DESCRIPTION

New emerging non volatile random access memory (NVRAM) technologies are being developed that have read and/or write latencies that are comparable with dynamic random access memory (DRAM). These emerging NVRAM memory technologies are being used to provide non volatility in main memory (also referred to as system memory), and/or, provide mass storage performance that has smaller access latencies than both disk drives and flash memory. Many of these emerging NVRAM technologies are composed of resistive storage cells that are formed in three-dimensional storage arrays above a semiconductor chip substrate (e.g., amongst the chip's interconnect wiring levels).

For example, the storage cells are “stacked” upon one another above the substrate but are separately addressable (e.g., by way of a “crosspoint” access architecture where a first set of access lines run orthogonal to a second set of access lines and a particular, accessed cell resides at the intersection of a pair of activated access lines). A higher resistive cell state corresponds to one logical state and a lower resistive cell state corresponds to another logical state. Examples of emerging NVRAM technologies are Optane™ memory from Intel Corporation or QuantX™ memory from Micron. More generally, emerging NVRAM technologies may be composed of phase change memory, state change memory, dielectric memory, ferroelectric memory, magnetic memory, spin transfer torque memory, among other possible technologies.

A concern with respect to a number of these technologies, however, is the power consumption during a write operation. Here, in order to “set” a resistive cell to a different logical state, a large amount of current needs to be driven through the cell and/or a large voltage needs to be applied across the cell to “flip” the cell's stored value. Thus, generally, any memory module containing a number of NVRAM memory chips should be designed to limit the number of write commands it receives over a time window so that the memory module's power budget is not exceeded.

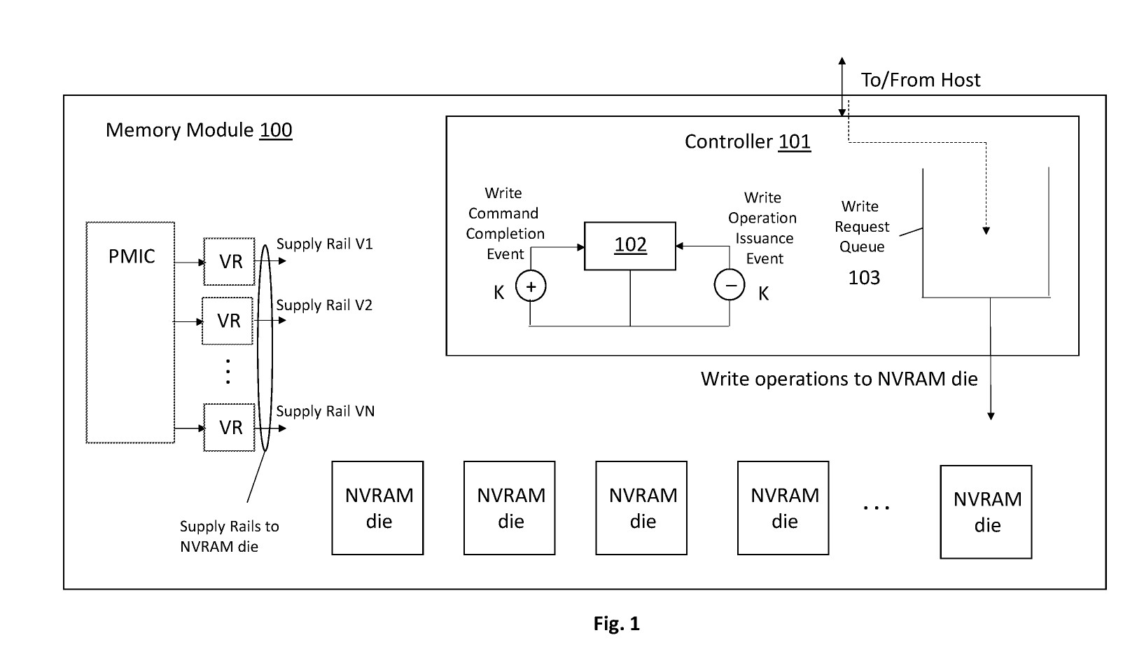

FIG. 1 shows a traditional design for limiting the number of writes an NVRAM memory module (e.g., dual in-line memory module (DIMM), stacked memory form factor memory module, etc.) or solid state drive (SSD), hereinafter, collectively, “module” 100 is able to execute over a time window. As observed in FIG. 1, the module 100 includes a controller 101 having a counter 102. The counter 102 is used to track how much head room exists in the module's power budget to execute additional writes operations. Here, write requests are received from a host and entered into a write queue 103. Write operations directed to the module's NVRAM die are physically effected by servicing the write requests from the queue 103.

The memory module's controller 101 decrements the value in the counter 102 by a fixed amount (“K”) each time a new write operation is performed (i.e., each time a write request is serviced from the write queue 103) to reflect the amount that the power budget headroom has been reduced by the newly commenced write operation. By contrast, each time a write operation is completed, the fixed amount is added to the counter value to reflect the increase in power budget headroom given that the particular write activity is no longer taking place.

If the counter value reaches zero (or some other low threshold value), the controller 101 will not accept any new write requests from the host. Depending on implementation, the controller 101 may continue to service write requests from the write queue 103 and perform the corresponding write operations (until the write queue 103 eventually empties), or, may also stop performing write operations altogether (stops servicing write requests from the write queue 103). If write operations continue to be performed, the controller 101 may force a slowdown in the rate at which write commands are serviced from the write queue 103, or, no such rate adjustment is made.

Regardless, because no new write requests are accepted from the host, write completions eventually outnumber active write operations which, in turn, causes the counter value to increase (increments outnumber decrements). Eventually the counter value climbs above some high threshold that signifies to the controller 101 that sufficient headroom exists to begin accepting new write requests from the host again and service them from the write queue 103.

A further complication, however, is a “time-sensitivity” phenomenon that affects the amount of energy needed to “flip” a storage cell to a new state (at least with respect to some NVRAM technologies). For example, the amount of energy needed to flip a storage cell can increase the longer the cell keeps the other, previously stored state (the energy approximately remains constant for writes that do not change the cell value).

Thus, in many situations, the aforementioned fixed value K that is used to adjust the power budget counter up or down per write operation/completion does not accurately reflect the amount of expended write energy. Rather, the amount of energy needed to execute any particular write operation is a function of the specific write pattern(s) that the targeted cell(s) have experienced and which the K value does not consider.

The actual power consumption profile of the NVRAM memory is therefore a function of how the host system uses the NVRAM module 100. That is, for example, different host systems running different software applications and/or applying same applications to different datasets can dramatically change an NVRAM module's observed pattern of write operations, and consequently, its power consumption.

According to a worst case scenario, the module's observed pattern of write operations includes keeping large amounts of data unchanged for long periods of time and then suddenly over-writing a large portion of this data with new data. So doing causes large numbers of cells that have held their data for extended periods of time to be concurrently over-written with new data. In this case, the module's actual remaining power budget will fall much more rapidly with each next write than what the counter value indicates because the energy consumed per write is closer to some multiple of the fixed value K (e.g., 1.4K, 1.5K, 2K, etc.)

Tracking write patterns on a per-cell basis in order to determine a more accurate value to decrement/increment from/to the power budget counter per write operation is not realistically feasible because the amount of data needed to fully track the write patterns made to each of the module's cells individually would exceed the storage capacity of the module 100.

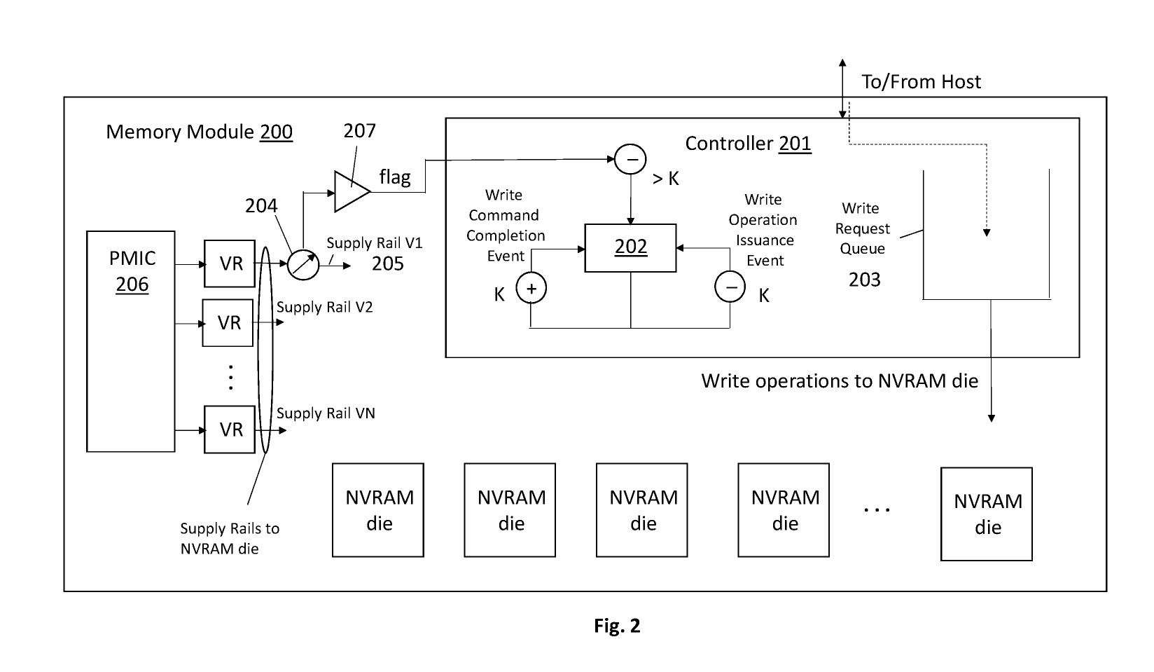

FIG. 2 therefore shows an improved design that includes an ammeter 204 coupled in series with a power rail 205 (“Supply Rail V1”) whose supply voltage is applied to the NVRAM memory cells during a write and observes an increase in current draw through the rail with increasing cell write energy. Here, FIG. 2 shows a power and management integrated circuit (PMIC) 206 that includes respective voltage regulators and/or controls external voltage regulators that provide the various supply voltages provided to the NVRAM die. Here, a single rail of same voltage may be coupled to all of the NVRAM chips, or, e.g., to distribute workloads/currents of a same supply voltage, multiple supply rails of same supply voltage may be coupled to different groups of NVRAM chips. For simplicity the following discussion assumes one supply rail of same voltage is supplied to all NVRAM chips.

In various embodiments, the particular power rail 205 that is chosen to have an ammeter 204 provides a special bias voltage that is used to bias a cell during a write to that cell. Here, the current draw from the rail 205 at any instant of time will be a function of the number of cells currently being written to and their respective write energies. Thus, if large numbers of cells that have held their data for an extensive period of time are suddenly over-written with new information, owing to the aforementioned time-sensitivity phenomenon, the current draw on the rail 205 should dramatically rise upward in response.

The output of ammeter 204 is coupled to flag circuit 207. As depicted in FIG. 2 the flag circuit 207 resides between the PMIC 206 and controller 201. However, in various embodiments the flag circuit 207 may be integrated within the PMIC 206 or within the controller 201. The flag circuit 207 is designed to raise a flag if the current draw on the power rail 205, as detected by the ammeter 204, rises above some high current threshold. If the current draw rises above this high threshold and the flag is raised by the flag circuit 207, the controller 201 activates a hard write throttle down sequence in response.

A first embodiment of the hard write throttle down sequence may be particularly useful if the flag is designed to be conservatively raised (the flag is raised even though substantial headroom exists between the maximum permitted module power consumption and the module's actual power consumption when the flag is raised). According to a first embodiment of the hard write throttle down sequence, a larger fixed value than the nominal fixed value (K) is used for unit decrements from the counter value. Here, the larger fixed value can correspond to a worst case (maximum) energy needed to flip a storage cell owing to the time-sensitivity phenomenon, or an even higher value (e.g., to account for worst case energy flips that have presumably already occurred but are not reflected in the current count value).

In this case, even though the flag has been raised, the controller 201 continues to receive write requests from the host and continues to service write requests from the write queue 203. Completions of writes that decremented the counter 201 by the larger amount correspondingly increment the counter by the larger amount. Operation continues unless and until the counter value falls below the low threshold at which point the controller 201 refuses to accept new write requests from the host. At this point, depending on implementation, the controller 201 can also stop issuing write operations from the write queue 203, or, continue to service the write queue 203 until it empties.

In most scenarios, particularly those in which the module 200 is experiencing a heavy continuous load of writes affected by the time-sensitivity phenomenon, the counter value will fall below the threshold. If the counter value does not fall below the threshold after the flag is raised, write activity must have lessened (causing the counter value to stabilize or climb higher) and a corresponding drop in current draw from the supply rail 205 should be observed. In this case, the detected current eventually falls beneath some low threshold which triggers the flag to reset (it no longer has raised or set status) and the increments/decrements switch back to their nominal value (K) rather than the larger value.

A second embodiment of the hard write throttle down may be particularly useful if the flag is designed to be raised when a tight/small margin exists between the module's maximum permitted power consumption and the module's actual power consumption when the flag is raised. According to the second embodiment of the hard write throttle down sequence, the counter value is immediately decremented so that it falls beneath its low threshold value (e.g., the difference between the counter value and its low threshold value+1 is subtracted from the counter value).

With the counter value having suddenly dropped below its low threshold, the controller 201 immediately stops accepting new write requests from the host. Again, depending on implementation, the controller 201 can also stop issuing write operations from the write queue 203, or, continue to service the write queue 203 until it empties. In an extension of the second embodiment, the counter value is not decremented and the controller 201, in direct response to the raising of the flag, simply enters a state in which it refuses to accept new write requests from the host (it may also stop servicing the write queue 203 or continue to service it until it empties depending on implementation).

Regardless, at least in the face of a heavy continuous load of time sensitivity phenomenon affected writes, the write activity of the module 200 will at least temporarily cease or slowdown as a consequence of the flag having been raised and the controller's refusal to accept new write requests from the host. The ceasing/slowing of the write activity, in turn, causes the memory module's current draw from the supply rail 205, as well as its overall power consumption, to decline.

In various embodiments, this reduced power consumption state is maintained for a sufficient length of time to bring the memory module's overall power/current consumption, over a time period that includes the detected rise in supply rail current that caused the flag to be set, to fall within the memory module's power/current consumption specifications.

According to one approach, the time period may be pre-set and marked from the time the low threshold of the count value is reached (e.g., in the case of the first embodiment above) or from the time the flag is raised (e.g., in the case of the second embodiment above). That is, for instance, a timer may be started once the low threshold of the count value is reached or the flag is raised. Then, upon expiration of the timer, the memory module 200 is deemed to have thwarted write activity for a sufficiently long enough time period to keep its overall power consumption in-check, and, the controller 201 is permitted to accept more write requests from the host and re-start servicing write commands from the write queue 203.

According to a second approach, the time period is marked by observance of the current draw on the supply rail 205. That is, when the current draw on the supply rail 205 is deemed to have sufficiently fallen in response to the diminished write activity, the flag is reset (lowered) and the controller 201 is permitted to accept write requests from the host and re-start servicing write commands from the write queue 203.

Some combination of these approaches may also be used (e.g., the timer must expire and the current draw on the rail must fall below a low threshold in order for the controller 201 to begin accepting new write requests from the host and re-start servicing write commands from the write queue).

In various embodiments, as part of permitting the controller 201 to entertain write requests from the host and service write operations from the queue 203, the counter value is reset to a value that reflects how much headroom is believed to exist in the power budget of the memory module 200 when write activity restarts. For example, if the time period of diminished write activity is sufficiently lengthy and/or the lower current threshold used to reset the flag is sufficiently low (e.g., to a value that indicates no write activity exists), the system can presume most or all of the memory module's power budget for performing writes has been restored. As such, the counter value is reset to a value that corresponds to the full power budget for write activity, or, a value that is near that value. The counter is then incremented down/up with nominally valued (K) decrements/increments as per normal operation going forward.

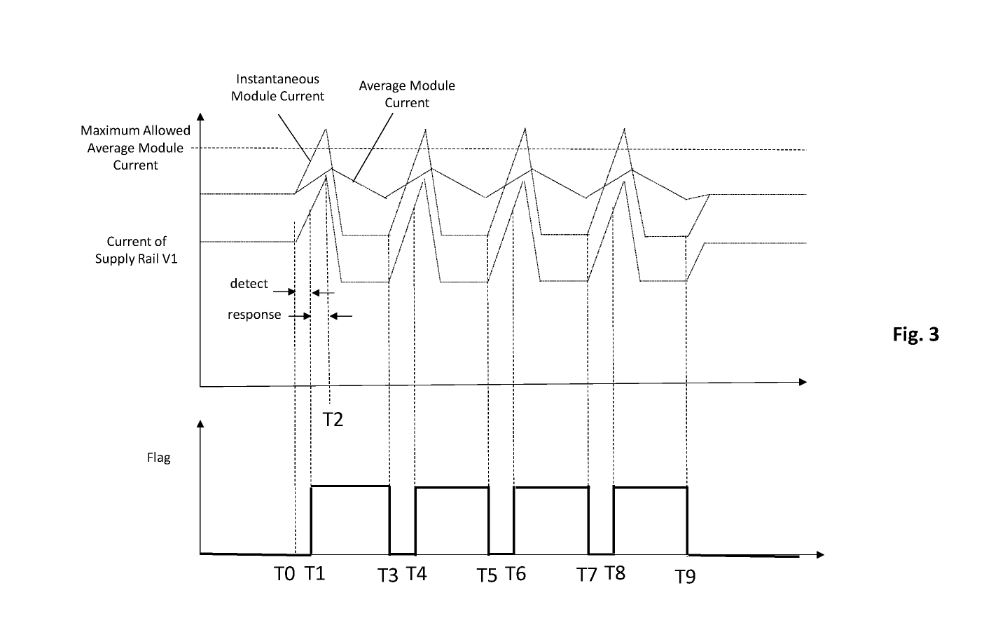

FIG. 3 provides a timing diagram for one embodiment of the improved write throttling technique in an environment where the host suddenly sends the memory module a sustained, heavy load of time sensitivity phenomenon affected writes. Here, as observed in FIG. 3, at time TO, the supply rail current suddenly ramps us, e.g., owing to a sudden stream of write commands that change data that has been stored in the respective NVRAM memory for a substantial period of time. In response to the current spike, the flag is raised at time T1. Once the flag is raised, the write activity of the memory module ceases/diminishes in response at time T2.

In response to the write activity being diminished for a sufficient amount of time that extends to time T3 at which time the flag is lowered and the memory module re-starts write activity. The process then repeats. That is, with the memory module still being sent a heavy load of time sensitivity phenomenon affected writes, the supply current will ramp upward again from time T3 resulting in the flag being set again at time T4. The loop continues to “chatter” until the host stops sending the memory module a heavy load of time sensitivity phenomenon affected writes. As depicted in FIG. 3, there is a cessation in the execution of the heavy load of time sensitivity phenomenon affected writes after T9 (the V1 supply current levels off to a normal level after T9). Notably, however, the average current draw of the memory module never exceeds its maximum limit because of the forced diminished write activity.

With respect to response times, note that there is some delay between when the current spike occurs (at TO) and when the flag is raised (at T1), and, there is some delay between when the flag is raised (at T1) and when the diminished write activity takes effect to cause the supply rail current to lower (at T2). The former can be referred to as the “detect” delay and the later can be referred to as the “response” delay. The detect delay is a function of the sensitivity and responsivity of the ammeter 204 and flag circuitry 207. The response delay is a function of the specific throttle down sequence that is used.

To first order, these delays must be brief enough so that the memory module's average current draw does not exceed its maximum allowed value before it begins to decline. In order to meet this criteria, as the aggregate of these delays increases, the memory module's time period of diminished write activity must correspondingly increase. That is, the higher the “peak” power that is exhibited by the module, the longer the write activity must be diminished in order to keep the average power consumption of the module within its maximum allowed limit.

Although the controller 201 described above and power circuitry (PMIC, voltage regulators, etc.) have been described as being integrated on the module in various alternative embodiments one or more of these may be located elsewhere (e.g., motherboard, host system on chip (SOC), etc.). Moreover, the module 200 may be a hybrid module having a mixture of different types of memory chips (e.g., DRAM and NVRAM).

The controller 201 may be implemented with dedicated, hardwired logic circuitry, programmable logic circuitry (e.g., field programmable gate array (FPGA) logic circuitry), logic circuitry designed to execute some form of program code (e.g., an embedded processor) or any combination of these. If an embedded processor is used, the embedded processor may execute firmware associated with the module to implement any/all of the methods described above.

In embodiments where multiple supply rails of the same (e.g., bias) voltage are coupled to different sets of the NVRAM chips, the basic design of FIG. 2 may be expanded to account for each rail and group of NVRAM chips (e.g., a first flag and ammeter are associated with a first group of NVRAM chips, a second flag and ammeter are associated with a second group of NVRAM chips). Respective counters may also be maintained for each such rail, and/or, the combined headroom for all NVRAM chips may be maintained in a single counter.

Although embodiments above have stressed limiting the write activity, conceivably, too much read and write activity or even too much read activity by itself could overwhelm certain modules. For example, a module having a tight power and/or thermal budget could begin to draw too much current if the module receives a heavy load of just reads or combination of reads and writes. In such cases, the teachings above can be expanded to limit reads and writes or even just reads. Here, for instance, if a second bias voltage is used to bias cells during a read, a current meter can be placed in series with the second bias rail. If a flag is raised from the second current meter, reads may be suppressed consistent with the teachings above and/or write may be suppressed. Likewise, if this approach is combined with any approaches described above in which a current meter is placed in series with a first bias rail that biases cells during a write operation, any flag raised from the current rail may be used to suppress not just writes but also reads. Likewise, a second counter that counts read activity may be coupled downstream from the second current meter and may be used to suppress/limit read activity. Further still, an “access” counter that counts read and write activity together may be coupled downstream from both current meters to limit access generally (reads and writes) in response to either of the flags being raised, or, may limit the one or the other type of access depending on which flag was raised.

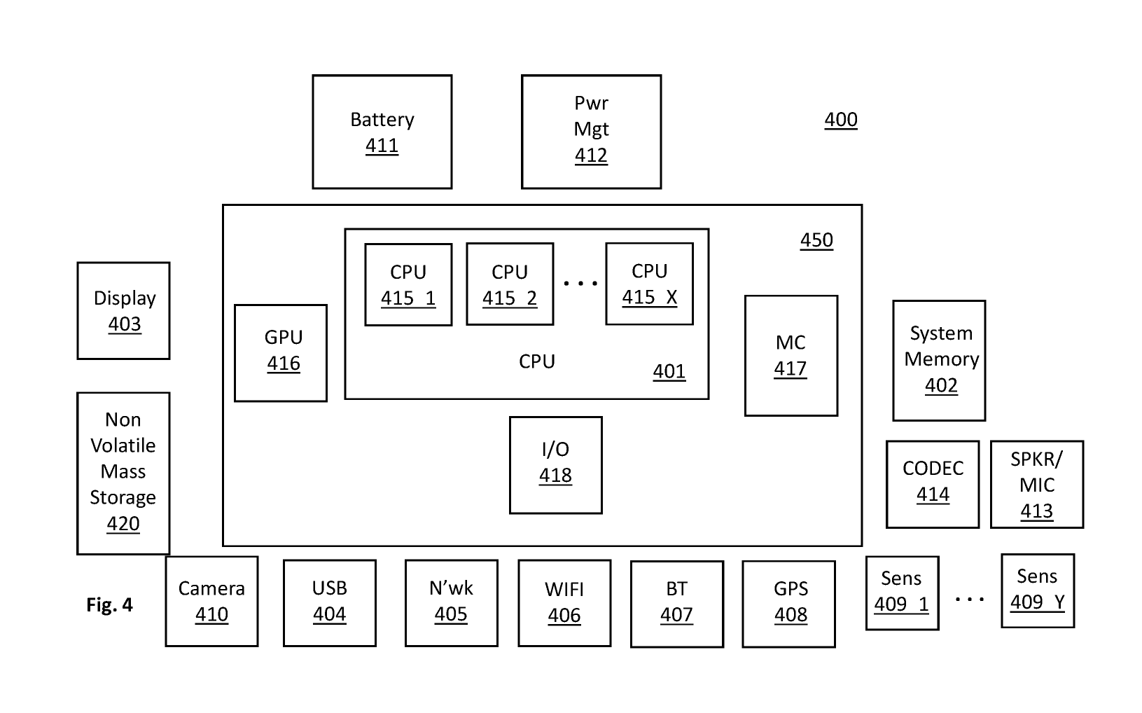

FIG. 4 provides an exemplary depiction of a computing system 400 (e.g., a smartphone, a tablet computer, a laptop computer, a desktop computer, a server computer, etc.). As observed in FIG. 4, the basic computing system 400 may include a central processing unit 401 (which may include, e.g., a plurality of general purpose processing cores 415_1 through 415_X) and a main memory controller 417 disposed on a multi-core processor or applications processor, system memory 402, a display 403 (e.g., touchscreen, flat-panel), a local wired point-to-point link (e.g., USB) interface 404, various network I/O functions 405 (such as an Ethernet interface and/or cellular modem subsystem), a wireless local area network (e.g., WiFi) interface 406, a wireless point-to-point link (e.g., Bluetooth) interface 407 and a Global Positioning System interface 408, various sensors 409_1 through 409_Y, one or more cameras 410, a battery 411, a power management control unit 412, a speaker and microphone 413 and an audio coder/decoder 414. The CPU 401 or other processor (e.g., GPU) or other high-performance semiconductor chip may include a heat sink assembly having a pre-loaded bolt as described herein and/or a carrier with anti-tile posts as described herein.

An applications processor or multi-core processor 450 can be an SOC that includes one or more general purpose processing cores 415 within its CPU 401, one or more graphical processing units 416, a memory management function 417 (e.g., a memory controller) and an I/O control function or peripheral controller 418. The general-purpose processing cores 415 typically execute the operating system and application software of the computing system. The graphics processing unit 416 typically executes graphics intensive functions to, e.g., generate graphics information that is presented on the display 403.

The memory control function 417 interfaces with the system memory 402 to write/read data to/from system memory 402. The system memory (or main memory) 402 may be a multi-tiered memory having a faster, upper layer of volatile memory (e.g., DRAM) and a slower, layer of non volatile memory (e.g., NVRAM). As such, a system memory module having the features described at length above may be integrated into the system memory. Likewise, any co-processors (e.g., graphics processors) having local memory may use a multi-tiered local memory or at least NVRAM in the local memory. As such, the local memory may be composed of a module have the features described above.

Each of the touchscreen display 403, the communication interfaces 404-407, the GPS interface 408, the sensors 409, the camera(s) 410, and the speaker/microphone codec 413, 414 all can be viewed as various forms of I/O (input and/or output) relative to the overall computing system including, where appropriate, an integrated peripheral device as well (e.g., the one or more cameras 410). Depending on implementation, various ones of these I/O components may be integrated on the applications processor/multi-core processor 450 or may be located off the die or outside the package of the applications processor/multi-core processor 450.

The computing system also includes non-volatile storage 420 which may be the mass storage component of the system. Here, the non-volatile mass storage 420 may be implemented with one or more mass storage modules (e.g., SSDs) having the features described at length above. As is understood in the art, an SSD is a mass storage device having non-volatile memory semiconductor chips as the storage media. SSDs can be packaged in various different ways or form factors (IC package with ball grid array, hard disk drive (HDD) form factor, mSATA, M.2, etc.).

Embodiments of the invention may include various processes as set forth above. The processes may be embodied in machine-executable instructions. The instructions can be used to cause a general-purpose or special-purpose processor to perform certain processes. Alternatively, these processes may be performed by specific/custom hardware components that contain hardwired logic circuitry or programmable logic circuitry (e.g., FPGA, PLD) for performing the processes, or by any combination of programmed computer components and custom hardware components. For example, a machine-readable storage medium may be used to store drawings of components described herein, and/or, of automated socket assembly/manufacturing processes described herein.

Therefore, elements of the present invention may also be provided as a machine-readable medium for storing the machine-executable instructions. The machine-readable medium may include, but is not limited to, floppy diskettes, optical disks, CD-ROMs, and magneto-optical disks, FLASH memory, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

1. An apparatus, comprising:
a memory module comprising a plurality of non volatile random access memory (NVRAM) semiconductor chips and a controller, the NVRAM semiconductor chips comprising a power supply rail whose current draw is proportional to the write activity of the NVRAM semiconductor chips, the controller comprising a counter to track NVRAM write operation power budget headroom, the controller comprising circuitry to cease or diminish NVRAM write operation activity in response to current draw of the power supply rail having reached a threshold.

2. The apparatus of claim 1 wherein the memory module is a DIMM.

3. The apparatus of claim 1 wherein the memory module is an SSD.

4. The apparatus of claim 1 wherein the memory module comprises stacked NVRAM semiconductor chips.

5. The apparatus of claim 1 wherein the controller is to decrement a value of the counter in response to a flag being raised in response to the threshold being reached.

6. The apparatus of claim 5 wherein the decrement of the value of the counter is larger than decrements made from the counter value in response to a nominal NVRAM write operation.

7. The apparatus of claim 5 wherein the controller is to stop accepting new write requests from a host in response to the flag being raised.

8. The apparatus of claim 5 wherein the controller comprises an input to receive an output from the ammeter and flag circuitry to generate the flag.

9. The apparatus of claim 1 wherein the memory module comprises a power management controller.

10. The apparatus of claim 1 wherein the power management controller includes or is coupled to flag circuitry, the flag circuitry to generate a flag in response to the threshold being reached.

11. A computing system, comprising:
a plurality of processing cores;
a system memory;
a memory controller coupled between the plurality of processing cores;
non volatile mass storage;
a networking interface;
a memory module implemented within the system memory or non volatile mass storage, the memory module comprising a plurality of non volatile random access memory (NVRAM) semiconductor chips and a controller, the NVRAM semiconductor chips comprising a power supply rail whose current draw is proportional to the write activity of the NVRAM semiconductor chips, the controller comprising a counter to track NVRAM write operation power budget headroom, the controller comprising circuitry to cease or diminish NVRAM write operation activity in response to current draw of the power supply rail surpassing a threshold.

12. The computing system of claim 11 wherein the memory module is one of:
a DIMM;
an SSD.

13. The computing system of claim 11 wherein the memory module comprises stacked NVRAM semiconductor chips.

14. The computing system of claim 11 wherein the controller is to decrement a value of the counter in response to a flag being raised in response to the threshold being reached.

15. The computing system of claim 14 wherein the decrement of the value of the counter is larger than decrements made from the counter value in response to a nominal NVRAM write operation.

16. The computing system of claim 14 wherein the controller is to stop accepting new write requests from a host in response to the flag being raised.

17. A method, comprising:
performing write operations on a plurality of NVRAM semiconductor chips of a memory module while tracking power budget headroom for performing the write operations and while monitoring current draw on a supply voltage rail that is coupled to the plurality of NVRAM semiconductor chips;
detecting the current draw has reached a threshold; and,
ceasing or diminishing the write operations in response to the detecting.

18. The method of claim 17 wherein the supply voltage rail provides a bias voltage for the write operations.

19. The method of claim 17 wherein the memory module is one of:
a DIMM;
an SSD.

20. The method of claim 17 further comprising decrementing a counter by a first amount during the tracking and decrementing the counter by a second, larger amount in response to the detecting.

21. An apparatus, comprising:
a memory module comprising a plurality of non volatile random access memory (NVRAM) semiconductor chips and a controller, the NVRAM semiconductor chips comprising a power supply rail whose current draw is proportional to access activity of the NVRAM semiconductor chips, the controller comprising a counter to track NVRAM access operation power budget headroom, the controller comprising circuitry to cease or diminish NVRAM access operation activity in response to current draw of the power supply rail having reached a threshold.
